(19) United States
(12) Patent Application Publication
(10) Pub. No.: US 2010/0068564 A1
(43) Pub. Date: Mar. 18, 2010

(54) APPARATUS FOR STABILIZING FUEL CELL AND METHOD THEREFOR

(75) Inventors: Wei-Hsiang SU, HSINCHU COUNTY (TW); Hsin-Ting LEE, HSINCHU COUNTY (TW)

Correspondence Address: BRIAN M. MCINNIS, 12th Floor, Ruttonjee House, 11 Duddell Street, Hong Kong, HK

(73) Assignee: SIMPLO TECHNOLOGY CO., LTD., HSINCHU HSIEN (TW)

(21) Appl. No.: 12/345,671

(22) Filed: Dec. 30, 2008

(30) Foreign Application Priority Data
Sep. 17, 2008 (TW) 97135681

(51) Int. Cl. H01M 8/04

(52) U.S. Cl. 429/13; 429/23

(57) ABSTRACT

An apparatus for stabilizing the fuel cell comprises a converter, a direct voltage detector and a regulating module. The converter can transform direct current generated from the fuel cell into electric power output, wherein a voltage of the electric power output is stable. The direct voltage detector can detect a direct voltage of the direct current. The regulating module can regulate an electric current of the electric power output according to the direct voltage of the direct current.

### RELATED APPLICATIONS

This application claims priority to Taiwan Application Serial Number 97135681, filed Sep. 17, 2008, which is herein incorporated by reference.

### BACKGROUND

1. Field of Invention

The present invention relates to an apparatus for controlling fuel cell. More particularly, the present invention relates to an apparatus for stabilizing the fuel cell.

2. Description of Related Art

Energy is the source power of all economic activities and thus is highly relative to the economic advancement. For the time being, energy sources include fossil energies such as petroleum, natural gas, and coal, nuclear power, waterpower, terrestrial heat and solar energy. Among the above-mentioned energy sources, fossil energies are the most widely used energy with nuclear power being in second place, whereas the others are much less commonly used. However, upon combustion, fossil energies produce greenhouse gas such as carbon dioxides, nitrogen oxides, sulfur oxides, and hydrocarbons that are detrimental to the environment. Hence, how to reduce greenhouse gas emission has become a major international issue.

In the past few decades, fuel cell is the new technology of the electric generation except wind power, waterpower, firepower, nuclear energy and solar energy power. Fuel cell as a power generated device is unlike the energy of the internal combustion engine generated by fuel combustion or the primary cell and the secondary cell that just store the electric power, unlike the internal the electric power generation by fuel cell comes from the electrochemical reaction that converts the chemical energy into electric energy with releasing water and heat. Fuel cell has less environmental pollution and brings the super efficiency of the energy conversion. The primary fuel needed by fuel cell is hydrogen gas, a newly categorized energy. Hence, fuel cell is a new desirable energy source for human beings that suffer from environmental pollution and energy shortage.

However, fuel cell still has some drawbacks and limitations to be solved such as the direct current generated by fuel cell is not quite stable. In view of the foregoing, there is the new apparatus and method for stabilizing fuel cell.

### SUMMARY

It is therefore an objective of the present invention to provide an apparatus for stabilizing a fuel cell.

In accordance with an embodiment of the present invention, the apparatus for stabilizing the fuel cell, comprises a converter, a direct voltage detector and a regulating module. The converter can transform direct current generated from the fuel cell into electric power output, wherein a voltage of the electric power output is stable. The direct voltage detector can detect a direct voltage of the direct current. The regulating module can regulate an electric current of the electric power output according to the direct voltage of the direct current.

It is another objective of the present invention to provide a method for stabilizing the fuel cell.

In accordance with another embodiment of the method for stabilizing the fuel cell, which comprises the following steps:

(1) Direct current generated from the fuel cell is transformed into electric power output, wherein a voltage of the electric power output is stable;

(2) A direct voltage of the direct current is detected; and

(3) An electric current of the electric power output is regulated according to the direct voltage of the direct current.

It is to be understood that the foregoing general description and the following detailed description are by examples, and are intended to provide further explanation of the invention as claimed.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of an apparatus for stabilizing a fuel cell according to an embodiment of the present invention;

FIG. 2 is a flow chart of a method for stabilizing a fuel cell according to another embodiment of the present invention; and

FIG. 3 is another flow chart of a method for stabilizing a fuel cell according to yet another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

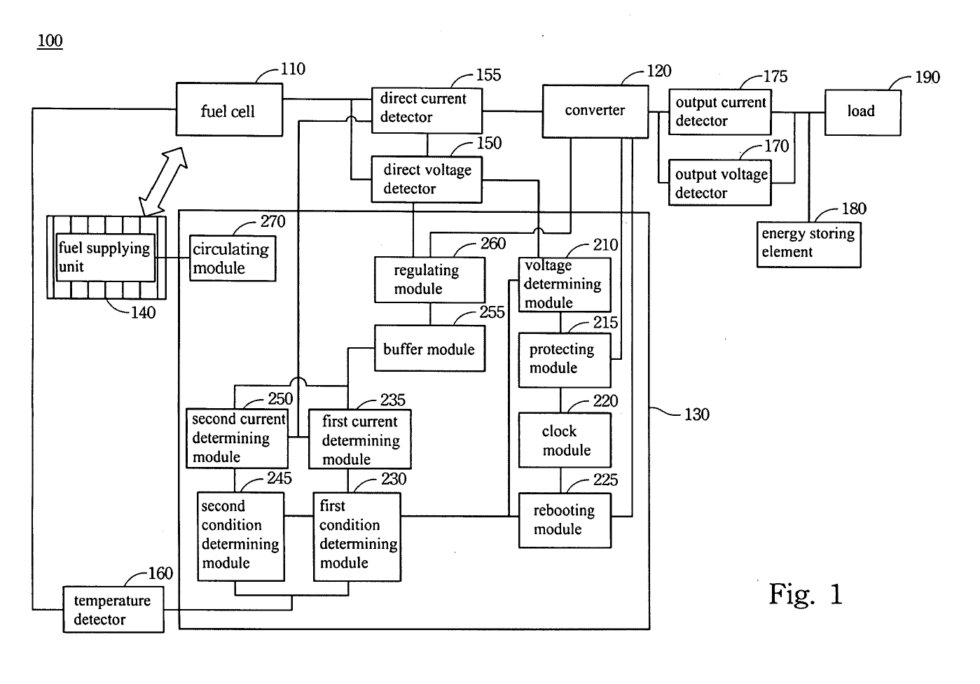

Please refer to FIG. 1. FIG. 1 is a block diagram of an apparatus for stabilizing a fuel cell according to an embodiment of the present invention In FIG. 1, the fuel cell 110 may be a polymer exchange membrane fuel cell (PEMFC), an alkaline fuel cell (AFC), a phosphoric acid fuel cell (PAFC), a direct methanol fuel cell (DMFC), a solid oxide fuel cell (SOFC), a molten carbonate fuel cell (MCFC) or the like.

In the embodiment, the apparatus 100 may comprise a fuel-supplying unit 140 and a circulating module 270. The fuel-supplying unit 140 can supply the fuel cell with fuel, water and air. The circulating module 270 can control fuel, water and air to keep on recurring. The fuel supplied by the fuel-supplying unit 140 may be hydrogen, which may be acquired from coal, petroleum, natural gas, fuel gas, methanol, alcohol, methane, electrolysis of water, firedamp or the like. In addition, the fuel is pure hydrogen perfectly. In fuel cell 110, fuel is not burned, but fuel and water are combined to generate water by the reaction of electrochemistry; thereby chemical energy is transformed into electric energy. In one word, this is a water-electrolyzing reverse reaction. The fuel-supplying unit 140 can supply water to eliminate the heat produced from the fuel cell 110, so as to maintain the electrochemistry reaction of the fuel cell 110 and stabilize its temperature. The fuel cell can send the surplus fuel and water produced by the electrochemistry reaction back to the fuel-supplying unit 140 for use again.

However, the direct current generated by the electrochemistry reaction of the fuel cell 110 is not stable. In the embodiment, the apparatus 100 further comprises the converter 120. The converter 120 can transform the direct current generated from the fuel cell 110 into electric power output, where a voltage of the electric power output is stable. Therefore, the converter 120 can supply the steady electric power output to the load 190.

Please continue to refer to FIG. 1. For the sake of operating the fuel cell 110 in optimum efficiency, the apparatus 100 may comprise a direct voltage detector 150 and a regulating module 260. In the embodiment, the fuel cell 110 can generate the direct current, and the converter 120 can output the electric power output. Thus, the direct voltage detector 150 can detect a direct voltage of the direct current. The regulating module 260 can regulate an electric current of the electric power output according to the direct voltage of the direct current. For example, the regulating module 260 may increase the electric current of the electric power output if the direct voltage of the direct current is raised; on the contrary, the regulating module 260 may reduce the electric current of the electric power output if the direct voltage of the direct current is dropped. Therefore, the direct voltage generated from the fuel cell 110 is changed indirectly by means of the converter 120, so that the fuel cell 110 is operated in optimum efficiency.

However, in general, the state of the fuel cell 110 is not steady. Accordingly, the state of the fuel cell 110 is tracked, so as to keep on controlling the converter 120.

Accordingly, the apparatus 100 may comprise a voltage-determining module 210 and protecting module 215. In the embodiment, the voltage-determining module 210 can determine whether the direct voltage of the direct current exceeds a protective voltage of the fuel cell 110, wherein the protective voltage is defined by the maximum rated voltage of the individual fuel cell in safe state. The different fuel cells 110 may refer to different protective voltages. With regard to the same kind of the fuel cell 110, the protective voltage is defined by the amount of membrane electrodes. The protecting module 215 can turn off the converter 120 when the direct voltage of the direct current is less than the protective voltage of the fuel cell 110, so as to avoid damaging the fuel cell 110.

In addition, the apparatus 100 may comprise a clock module 220 and a rebooting module 225. In the embodiment, when the direct voltage of the direct current exceeds the protective voltage of the fuel cell 110, the clock module 220 can calculate a protective period according to the characteristic of the fuel cell 110. The direct voltage of the direct current of the fuel cell 110 should be less than what the above-mentioned protective voltage exceeds during the protective period. The rebooting module 225 can reboot the converter 120 after the protective period, so that the converter 120 can transform direct current generated from the fuel cell into electric power output.

In FIG. 1, the apparatus 100 may comprise a temperature detector 160. In the embodiment, the temperature detector 160 can detect the temperature of the fuel cell 110. According to the characteristic of the fuel cell 110, the direct voltage of the direct current of the fuel cell 110 is related to the temperature of the fuel cell 110.

Accordingly, in order to ensure that the fuel cell 110 is operated under the normal voltage and temperature, the apparatus 100 may comprise a first condition-determining module 230, a direct current detector 155 and a first current determining module 235. In the embodiment, the first condition determining module 230 can determine whether the direct voltage of the direct current and the temperature of the fuel cell 110 correspond with a first predetermined condition when the direct voltage of the direct current exceeds the protective voltage of the fuel cell 110 or the first predetermined condition is that the direct voltage of the direct current exceeds the first predetermined voltage and the temperature of the fuel cell 110 is less than a predetermined temperature. In addition, the first predetermined temperature is set according to the characteristic of the fuel cell 110, and the first predetermined voltage may be greater than the protective voltage of the fuel cell 110, which signifies that the fuel cell 110 is not suited to output large direct current when the temperature and the direct voltage of the fuel cell 110 are low to prevent. Otherwise, the fuel cell 110 may have a breakdown under the above-mentioned condition.

Under the satisfaction of the first predetermined condition, the direct current detector can detect the amperage of the direct current in order to prevent that the direct current generated from the fuel cell 110 is too large to malfunction. The first current determining module 235 can determine whether the amperage of the direct current exceeds a rated current of the fuel cell when the direct voltage of the direct current and the temperature of the fuel cell 110 correspond with the first predetermined condition. The different fuel cells 110 may refer to different protective voltages. With regard to the same kind of the fuel cell 110, the protective voltage is defined by the amount of membrane electrodes.

In addition, the higher the temperature and the direct voltage of the fuel cell 110 are, the more direct current of the fuel cell 110 should be outputted to prevent a breakdown. And further, the apparatus 100 may comprise a second condition determining module 245 and a second current determining module 250. In the embodiment, the second condition determining module 245 can determine whether the direct voltage of the direct current and the temperature of the fuel cell 110 correspond with a second predetermined condition when the direct voltage of the direct current and the temperature of the fuel cell 100 do not correspond with the first predetermined condition, where the second predetermined condition is that the direct voltage of the direct current exceeds a second predetermined voltage and the temperature of the fuel cell 110 exceeds the predetermined temperature, wherein the second predetermined voltage exceeds the protective voltage of the fuel cell 110 and is less than the first predetermined voltage.

Under the satisfaction of the second predetermined condition, the direct voltage detector 155 can detect the amperage of the direct current in order to prevent that the direct current generated from the fuel cell 110 is too large to malfunction. The second current determining module 250 can determine whether the amperage of the direct current exceeds the rated current of the fuel cell 110 when the direct voltage of the direct current and the temperature of the fuel cell 110 correspond with the second predetermined condition.

For the sake of operating the fuel cell 110 in optimum efficiency, the apparatus 100 may comprise a buffer module 255. In the embodiment, the buffer module 255 can calculate a delta time according to the characteristic of the fuel cell 110 when the amperage of the direct current is less than the rated current of the fuel cell 110. The buffer module 255 may adjust the delta time in accordance with the real state of the apparatus 100. After a delta time, the regulating module 260 can regulate the electric current of the electric power output of the converter 120, so that the fuel cell 110 is operated in optimum efficiency by means of the indirect change of the direct voltage.

It should be noted that the voltage-determining module 210, the protecting module 215, the clock module 220, the rebooting module 225, the first condition-determining module 230, the first current determining module 235, the second condition determining module 245, the second current determining module 250, the buffer module 255, the regulating module 260, the circulating module 270 and the embodiments thereof may use software or a circuit. It will be readily understood by those skilled in the art that methods may be varied while remaining within the scope of the present invention. For example, the voltage-determining module 210, the protecting module 215, the clock module 220, the rebooting module 225, the first condition-determining module 230, the first current determining module 235, the second condition determining module 245, the second current determining module 250, the buffer module 255, the regulating module 260 and the circulating module 270 can be integrated in one microprocessor 130.

In addition, in order to measure the output power of the converter 120, the apparatus 100 may comprise an output voltage detector 170 and an output current detector 175. In the embodiment, the output voltage detector 170 can detect the voltage of the electric power output. The output current detector 175 can detect the electric current of the electric power output. Therefore, the electric power output of the converter 120 may be calculated according to the voltage and the electric current of the electric power output.

In addition, in order to avoid that the load 190 has no power when the converter 120 is turned off, the apparatus 100 may comprise an energy-storing element 180. In the embodiment, the energy-storing element 180 can store a part of the electric power output as electric energy. Therefore, the energy-storing element 180 can load 190 with the storage when the converter 120 is turned off. For example, the energy-storing element 180 may be a battery, a capacitor or the like.

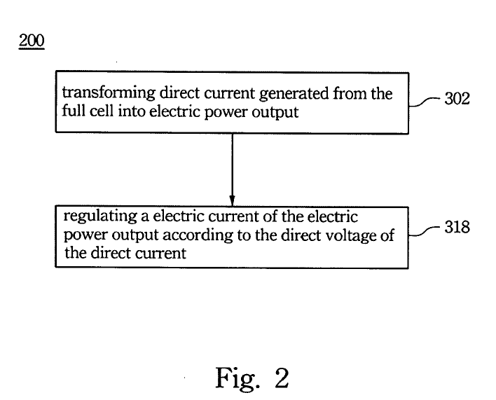

For a more complete understanding of the present disclosure, and the advantages thereof, please refer to FIG. 2. FIG. 2 is a flow chart of a method for stabilizing a fuel cell according to another embodiment of the present invention. In step 302, the fuel cell outputs the direct current generated from the fuel cell as the electric power output by the converter, where the voltage of the electric power output is stable. In step 318, the direct voltage of the direct current generated from the fuel cell can regulate the electric current of the electric power output. For example, in step 318, the electric current of the electric power output may increase if the direct voltage of the direct current increases; on the contrary, the electric current of the electric power output may decrease if the direct voltage of the direct current decreases. Therefore, the fuel cell 110 is operated in optimum efficiency by means of the indirect change of the direct voltage.

However, in general, the state of the fuel cell is not steady. Hence, the state of the fuel cell may be tracked, so as to keep on controlling the converter 120.

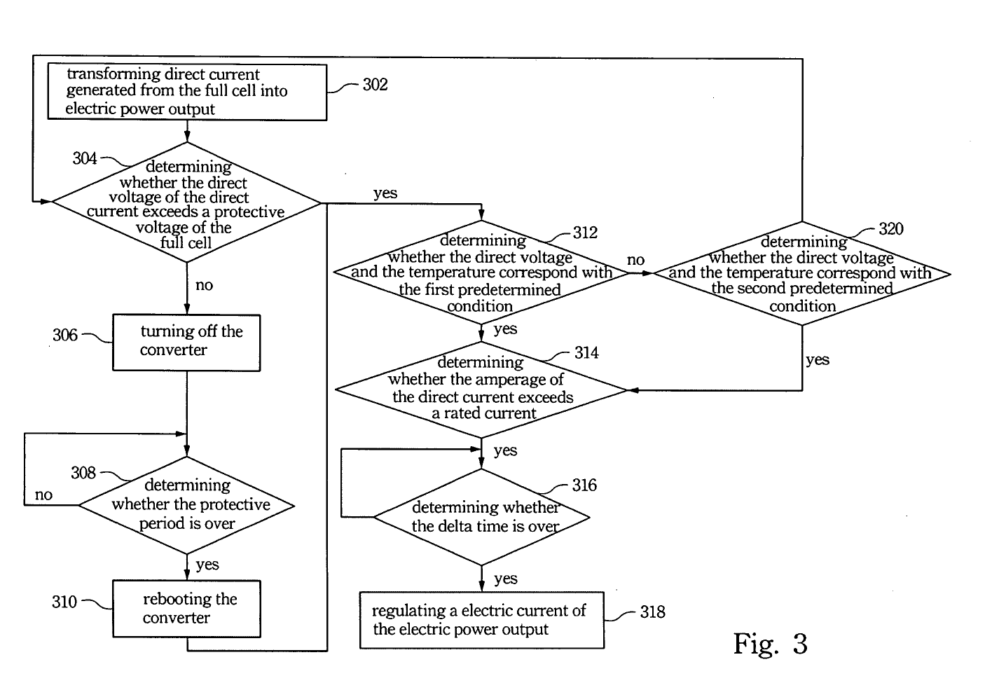

Accordingly, please refer to FIG. 3. FIG. 3 is another flow chart of a method for stabilizing a fuel cell according to yet another embodiment of the present invention. In step 304, whether the direct voltage of the direct current exceeds a protective voltage of the fuel cell 110 is determined, where the protective voltage is in accordance with a maximum rated voltage of the fuel cell in the steady state. Then, in step 306, the converter 120 is turned off when the direct voltage of the direct current is less than the protective voltage of the fuel cell 110, so as to avoid damaging the fuel cell 110 because the direct voltage of the direct current is overloaded.

In step 308, a protective period is calculated according to the characteristic of the fuel cell when the direct voltage of the direct current exceeds the protective voltage of the fuel cell, and then whether the protective period is over is determined. The direct voltage of the direct current of the fuel cell should be less than what the above-mentioned protective voltage exceeds during the protective period. In step 310, the converter is rebooted after the protective period, so that the converter can transform the direct current generated from the fuel cell into electric power output, where the voltage of the electric power output is stable.

According to the characteristic of the fuel cell, the direct voltage of the direct current of the fuel cell is related to the temperature of the fuel cell. In order to ensure that the fuel cell is operated under the normal voltage and the normal temperature after step 304 or step 310, therefore, in step 312, whether the direct voltage of the direct current and the temperature of the fuel cell correspond with a first predetermined condition is determined when the direct voltage of the direct current exceeds the protective voltage of the fuel cell or after the converter is rebooted, where the first predetermined condition is that the direct voltage of the direct current exceeds a first predetermined voltage and the temperature of the fuel cell is less than the first predetermined temperature. In addition, the first predetermined temperature is set according to the characteristic of the fuel cell, and the first predetermined voltage may exceed the protective voltage of the fuel cell, which signifies that the fuel cell is not suitable to output the large direct current to avoid a breakdown when the temperature and the direct voltage of the fuel cell are low.

In order to prevent that the direct current generated from the fuel cell is too large to malfunction when the state of the fuel cell corresponds with the first predetermined condition, in step 314, the amperage of the direct current is detected for judging if the direct current exceeds the rated current of the full cell.

In addition, step 312 is executed to further ensure that the fuel cell is operated under the normal voltage and temperature if the direct voltage of the direct current and the temperature of the fuel cell do not correspond with the first predetermined condition. In step 320, whether the direct voltage of the direct current and the temperature of the fuel cell correspond with the second predetermined condition is determined when the direct voltage of the direct current and the temperature of the fuel cell do not correspond with the first predetermined condition, where the second predetermined condition is that the direct voltage of the direct current exceeds a second predetermined voltage and the temperature of the fuel cell exceeds the predetermined temperature, wherein the second predetermined voltage exceeds the protective voltage of the fuel cell and is less than the first predetermined voltage. Therefore, the higher the temperature and the direct voltage of the fuel cell 110 are, the more direct current of the fuel cell 110 should be outputted to prevent a breakdown.

In order to prevent that the direct current generated from the fuel cell is too large to malfunction when the state of the fuel cell corresponds with the second predetermined condition, in step 314, the amperage of the direct current is detected for judging if the direct current exceeds the rated current of the full cell.

In step 316, when the amperage of the direct current is less than the rated current of the fuel cell, the delta time is calculated and determined if it is overtime according to the characteristic of the fuel cell, After the delta time, in step 318, the convert can regulate the electric current of the electric power output. Thus, the fuel cell 110 is operated in optimum efficiency by means of the indirect change of the direct voltage.

In addition, in order to measure the power output of the converter, the method 200 may comprise the following steps:

(1) The electric current of the electric power output is detected; and

(2) The voltage of the electric power output is detected.

Therefore, the electric power output of the converter 120 may be calculated according to the voltage and the electric current of the electric power output.

In addition, in order to avoid that the load has no power when the converter is turned off, the method 200 may comprise the following steps:

(1) A part of the electric power output as electric energy is stored.

Therefore, the load is supplied with the stored electric power when the converter is turned off. For example, the electric energy is stored by the energy-storing element, such as a battery, a capacitor or the like.

In addition, the method 200 comprise following steps:

(1) The fuel cell with fuel, water and air is supplied; and

(2) The fuel, the water and the air is controlled to keep on recurring.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An apparatus for stabilizing a fuel cell, comprising:
a converter for transforming direct current generated from the fuel cell into electric power output, wherein a voltage of the electric power output is stable;
means for detecting a direct voltage of the direct current; and
means for regulating an electric current of the electric power output according to the direct voltage of the direct current.

2. The apparatus as claimed in claim 1, further comprising:
means for determining whether the direct voltage of the direct current exceeds a protective voltage of the fuel cell;
means for turning off the converter when the direct voltage of the direct current is less than the protective voltage of the fuel cell;
means for calculating a protective period when the direct voltage of the direct current exceeds the protective voltage of the fuel cell; and
means for rebooting the converter after the protective period.

3. The apparatus as claimed in claim 2, further comprising:
means for detecting a temperature of the fuel cell.

4. The apparatus as claimed in claim 3, further comprising:
means for determining whether the direct voltage of the direct current and the temperature of the fuel cell correspond with a first predetermined condition when the direct voltage of the direct current exceeds the protective voltage of the fuel cell, wherein the first predetermined condition is that the direct voltage of the direct current exceeds a first predetermined voltage and the temperature of the fuel cell is less than a predetermined temperature, wherein the first predetermined voltage exceeds the protective voltage;
means for detecting an amperage of the direct current; and
means for determining whether the amperage of the direct current exceeds the rated current of the fuel cell when the direct voltage of the direct current and the temperature of the fuel cell correspond with the first predetermined condition.

5. The apparatus as claimed in claim 4, further comprising:
means for determining whether the direct voltage of the direct current and the temperature of the fuel cell correspond with a second predetermined condition when the direct voltage of the direct current and the temperature of the fuel cell do not correspond with the first predetermined condition, wherein the second predetermined condition is that the direct voltage of the direct current exceeds a second predetermined voltage and the temperature of the fuel cell exceeds the predetermined temperature, wherein the second predetermined voltage exceeds the protective voltage of the fuel cell and is less than the first predetermined voltage; and
means for determining whether the amperage of the direct current exceeds the rated current of the fuel cell when the direct voltage of the direct current and the temperature of the fuel cell correspond with the second predetermined condition.

6. The apparatus as claimed in claim 4, further comprising:
means for calculating a delta time when the amperage of the direct current is less than the rated current of the fuel cell; and
means for regulating the electric current of the electric power output according to the direct voltage of the direct current anew after the delta time.

7. The apparatus as claimed in claim 1, further comprising:
means for detecting the electric current of the electric power output; and
means for detecting the voltage of the electric power output.

8. The apparatus as claimed in claim 1, further comprising:
means for storing a part of the electric power output as electric energy.

9. The apparatus as claimed in claim 1, further comprising:
means for supplying the fuel cell with fuel, water and air; and
means for controlling fuel, water and air to keep on recurring.

10. A method for stabilizing a fuel cell, comprising:
transforming direct current generated from the fuel cell into electric power output by a converter, wherein a voltage of the electric power output is stable;
detecting a direct voltage of the direct current; and
regulating an electric current of the electric power output according to the direct voltage of the direct current.

11. The method as claimed in claim 10, further comprising:
determining whether the direct voltage of the direct current exceeds a protective voltage of the fuel cell;
turning off the converter when the direct voltage of the direct current is less than the protective voltage of the fuel cell;
calculating a protective period when the direct voltage of the direct current exceeds a protective voltage of the fuel cell; and
rebooting the converter after the protective period.

12. The method as claimed in claim 11, further comprising:
detecting a temperature of the fuel cell.

13. The method as claimed in claim 12, further comprising:
determining whether the direct voltage of the direct current and the temperature of the fuel cell correspond with a first predetermined condition when the direct voltage of the direct current exceeds the protective voltage of the fuel cell, wherein the first predetermined condition is that the direct voltage of the direct current exceeds a first predetermined voltage and the temperature of the fuel cell is less than a predetermined temperature, wherein the first predetermined voltage exceeds the protective voltage;
detecting a amperage of the direct current; and
determining whether the amperage of the direct current exceeds a rated current of the fuel cell when the direct voltage of the direct current and the temperature of the fuel cell correspond with the second predetermined condition.

14. The method as claimed in claim 13, further comprising:
determining whether the direct voltage of the direct current and the temperature of the fuel cell correspond with a second predetermined condition when the direct voltage of the direct current and the temperature of the fuel cell do not correspond with the first predetermined condition, wherein the second predetermined condition is that the direct voltage of the direct current exceeds a second predetermined voltage and the temperature of the fuel cell exceeds the predetermined temperature, wherein the second predetermined voltage exceeds the protective voltage of the fuel cell and is less than the first predetermined voltage; and
determining whether the amperage of the direct current exceeds the rated current of the fuel cell when the direct voltage of the direct current and the temperature of the fuel cell correspond with the first predetermined is condition.

15. The method as claimed in claim 13, further comprising:
calculating a delta time when the amperage of the direct current is less than the rated current of the fuel cell; and
regulating the electric current of the electric power output according to the direct voltage of the direct current anew after the delta time.

16. The method as claimed in claim 10, further comprising:
detecting the electric current of the electric power output; and
detecting the voltage of the electric power output.

17. The method as claimed in claim 10, further comprising:
storing a part of the electric power output as electric energy.

18. The method as claimed in claim 10, further comprising:
supplying the fuel cell with fuel, water and air; and
controlling fuel, water and air to keep on recurring.
